(19) United States
(12) Patent Application Publication
(10) Pub. No.: US 2007/0140145 A1
(43) Pub. Date: Jun. 21, 2007

(54) System, method and apparatus for authentication of nodes in an Ad Hoc network

(76) Inventors: Surender Kumar, Naperville, IL (US); Jeffrey D. Bonta, Arlington Heights, IL (US); Thomas C. Hill, Crystal Lake, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/314,274

(22) Filed: Dec. 21, 2005

(51) Int. Cl. H04L 12/28; H04L 12/56

(52) U.S. Cl. 370/254; 370/400

(57) ABSTRACT

A method and apparatus are provided for authenticating a first node M 220M in an ad hoc network 200. Node I 220I can receive a request from node M 220M to join the ad hoc network 200. This request includes, among other things, a biometric input associated with a first user of the node M 220M. Before the node M 220M is permitted to join the ad-hoc network, Node I 220I can authenticate the first user based on the biometric input by determining whether the biometric input matches biometric codes stored in Node I 220I.

### CROSS-REFERENCE TO RELATED APPLICATION

Related subject matter is described in a U.S. patent application by Kumar et. al. entitled “SYSTEM, METHOD AND APPARATUS FOR SELF-CONFIGURATION AND COMMUNICATION BETWEEN NODES IN AN AD HOC NETWORK”, (Atty. Docket No. CM08710STAR), filed concurrently herewith, the entire content being incorporated herein by reference.

### FIELD OF THE INVENTION

The present invention relates generally to wireless communications and more particularly to authentication of nodes in mobile ad hoc networks.

### BACKGROUND

Wireless networks have experienced increased development in the past decade. Two types of wireless networks are infra-structured wireless networks, and ad-hoc wireless networks.

An infra-structured wireless network typically includes a communication network with fixed and wired gateways. Many infra-structured wireless networks employ a mobile unit which communicates with a fixed base station that is coupled to a wired network. The mobile unit can move geographically while it is communicating over a wireless link to the fixed base station. When the mobile unit moves out of range of one base station, it connects or performs a “handover” to a new base station and starts communicating with the wired network through the new base station.

The core network typically has an authentication, authorization, and accounting (AAA) center, which monitors packet traffic to and from each wireless device. The AAA center provides a framework for intelligently controlling access to communication resources, enforces policies, audits usage, and provides the information necessary to bill for services. Authentication provides a way of identifying a user, typically by having the user enter a valid user name and valid password before access is granted. The process of authentication is based on each user having a unique set of criteria for gaining access. The AAA center compares a user's authentication credentials with other user credentials stored in a database. If the credentials match, the user is granted access to the network. If the credentials are at variance, authentication fails and network access is denied. Following authentication, a user can gain authorization for doing certain tasks. After logging into a system, for instance, the user may try to issue commands. The authorization process determines whether the user has the authority to issue such commands, including but not limited to, determining what types or qualities of activities, resources, or services a user is permitted. Typically, authorization occurs within the context of authentication. Once a user is authenticated, they may be authorized for different types of access or activity.

Recently, some wireless handsets have incorporated a fingerprint sensor to prevent unauthorized handset use. The user can unlock the handset simply by placing a pre-registered finger on the sensor.

In comparison to infra-structured wireless networks, such as cellular networks or satellite networks, ad hoc networks are self-forming networks which can operate in the absence of any fixed infrastructure, and in some cases the ad hoc network is formed entirely of mobile nodes (e.g., a peer-to-peer ad hoc network). An ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infra-structured or wired network. Ad hoc networks can also be self-healing. Links or connections between these nodes can change dynamically in an arbitrary manner as existing nodes move within the ad hoc network, as new nodes join or enter the ad hoc network, or as existing nodes leave or exit the ad hoc network. Because the topology of an ad hoc network can change significantly techniques are needed which can allow the ad hoc network to dynamically adjust to these changes. Due to the lack of a fixed infrastructure (e.g., a central controller), many network-controlling functions can be distributed among the nodes such that the nodes can self-organize and reconfigure in response to topology changes.

One characteristic of the nodes is that their transmission range is usually relatively limited in comparison to cellular networks. Each node can typically communicate over a short range with nodes which are a single “hop” away. Such nodes are sometimes referred to as “neighbor nodes.” Since ad hoc networks lack infrastructure, each node in an ad hoc network relies on other nodes in the network to help to forward/route/relay its packets (e.g., data and control information) throughout the network until the packets reach their intended destination. For example, when a node transmits packets to a destination node and the nodes are separated by more than one hop (e.g., the distance between two nodes exceeds the radio transmission range of the nodes, or a physical barrier is present between the nodes), the packets can be relayed via intermediate nodes (“hop-by-hop”) until the packets reach the destination node. Each intermediate node acts as a router which can intelligently route the packets (e.g., data and control information) to another node until the packets eventually reach their final destination. For instance, if the destination is a user connected to the Internet, packets sent from a source node to that user will “hop” or be routed by intermediate nodes until they reach a cellular base station, a Wireless Local Area Network (WLAN) Access Point (AP) or other gateway to the Internet.

To facilitate the relaying of packets, each node maintains routes or routing information to other nodes in the network and can utilize routing techniques to adapt to changes in the interconnectivity between nodes. The nodes can maintain this routing information by performing periodic link and topology updates.

Because ad hoc networks lack a centralized infrastructure, nodes can not rely on authentication techniques used in infrastructure based networks. Commercial infrastructure based methods that exist today are difficult and complex to deploy. Authentication concerns for security and administration that exist for infrastructure based networks are also applicable in ad hoc networks. There is a need for mechanisms that will enable users, particularly technically unsophisticated users, to deploy and manage peer-to-peer ad hoc networks.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an exemplary node in accordance with some embodiments of the invention;

FIG. 2 is a block diagram of an exemplary peer-to-peer ad hoc communication network;

FIG. 3 is a block diagram of an exemplary ad hoc communication network as a new node attempts to join the ad hoc communication network;

FIG. 4 is a flowchart showing an exemplary method for authenticating a node in an ad hoc network in accordance with some embodiments of the invention;

FIG. 5 is a call flow diagram showing message exchanges between two nodes in an exemplary method for authenticating a node in an ad hoc network in accordance with some embodiments of the invention; and

FIG. 6 is a call flow diagram showing message exchanges between two nodes in another exemplary method for authenticating a node in an ad hoc network in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to authenticating a node in an ad hoc network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions for authenticating a node in an ad hoc network as described herein. The non-processor circuits may include, but are not limited to, a radio receiver, a radio transmitter, signal drivers, clock circuits, power source circuits, and user input devices. As such, these functions may be interpreted as steps of a method for authenticating a node in an ad hoc network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

Techniques are provided for use in peer-to-peer ad hoc networks which can allow for improved authentication procedures. Each authentication attempt by a particular node to bond to or associate with other nodes will succeed only if the particular node has a particular biometric code. Authentication is greatly simplified via the use of biometric information and the keys or codes provided from that biometric information. Each node or device in the ad hoc network can have a secure database which stores a list of codes or keys associated with other nodes in the ad hoc network. These codes or keys can be derived from biometric information from the users of the particular devices. Each node that has a biometric input device which allows a user to input biometric information that is converted to a key or code for that device. Any device in the ad hoc network can decide whether or not it wants to permit communication with another device by determining whether that device has a biometric key or code that matches one that is stored in the device. If the biometric key or code matches then communication can be permitted. By contrast if the key does not match then communication may not be permitted.

Overview of Biometrics

Biometrics are measurements of an individual's unique physical, behavioral, and biological qualities. Biometrics can be used to provide techniques for identifying, recognizing or verifying a person's identity based on a physiological or behavioral characteristic. Among the features that can be measured biometrically are: face, fingerprints, hand geometry, handwriting, iris, retinal, vein, and voice. Biometrics can be used to determine a person's identity from a physical characteristic (e.g., fingerprint, handprint, face, scent, thermal image, voice or iris pattern), or a behavior pattern (e.g., voice or handwriting signature). Biometric technologies can provide an extensive array of highly secure identification and personal verification solutions.

Biometric Authentication

Biometrics can be applied for authentication of a user. Biometric authentication involves comparing a registered or enrolled biometric sample (biometric template or identifier) against a newly captured biometric sample each time the user attempts to do something (for example, the one captured during a login). For example, in a given system, each authorized user can be “enrolled” by submitting a sample of biometric enrollment data (BED) or biometric input from that user. The BED can then be processed and stored as biometric enrollment information (BEI). At this point, the user is “enrolled.” This process is repeated for each authorized user.

To later identify or verify a person based on a biometric characteristic, a new biometric sample is taken from the person and compared to stored biometric enrollment information (BEI). If the new biometric sample matches one of the stored BEIs, then the identity of the person is confirmed or verified.

Exemplary Node for Use In Highly Secure Ad Hoc Networks

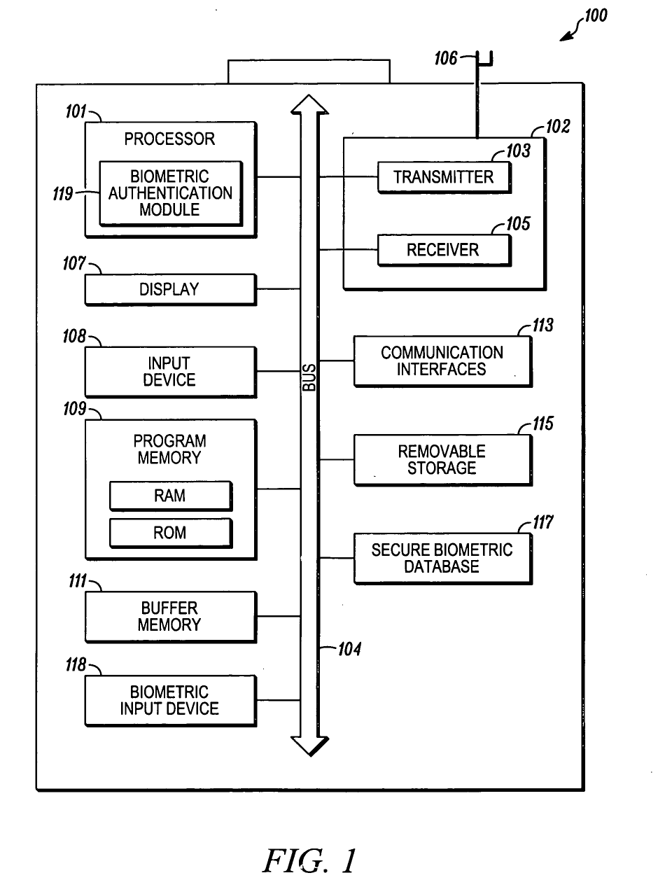

FIG. 1 is a block diagram of an exemplary node 100 in accordance with some embodiments of the invention. The node 100 comprises a processor 101, a transceiver 102 including a transmitter circuitry 103 and a receiver circuitry 105, an antenna 106, a display 107, an input device 108, a program memory 109 for storing operating instructions that are executed by the processor 101, a buffer memory 111, one or more communication interfaces 113, a removable storage unit 115, a secure biometric data base 117 and a biometric input device 118. Although not shown, the node 100 also preferably includes an antenna switch, duplexer, circulator, or other highly isolative means (not shown) for intermittently providing information packets from the transmitter circuitry 103 to the antenna 106 and from the antenna 106 to the receiver circuitry 105. The node 100 is preferably an integrated unit containing at least all the elements depicted in FIG. 1, as well as any other elements necessary for the node 100 to perform its particular functions. Alternatively, the node 100 may comprise a collection of appropriately interconnected units or devices, wherein such units or devices perform functions that are equivalent to the functions performed by the elements of the node 100. For example, the node 100 may comprise a laptop computer and a wireless LAN (local area network) card.

The processor 101 preferably includes one or more microprocessors, microcontrollers, DSPs (digital signal processors), state machines, logic circuitry, or any other device or devices that process information based on operational or programming instructions. Such operational or programming instructions are preferably stored in the program memory 109. The program memory 109 may be an IC (integrated circuit) memory chip containing any form of RAM (random-access memory) or ROM (read-only memory), a floppy disk, a CD-ROM (compact disk read-only memory), a hard disk drive, a DVD (digital video disc), a flash memory card or any other medium for storing digital information. One of ordinary skill in the art will recognize that when the processor 101 has one or more of its functions performed by a state machine or logic circuitry, the memory 109 containing the corresponding operational instructions may be embedded within the state machine or logic circuitry. The operations performed by the processor 101 and the rest of the node 100 are described in detail below.

The transmitter circuitry 103 and the receiver circuitry 105 enable the node 100 to communicate information packets to and acquire information packets from the other nodes. In this regard, the transmitter circuitry 103 and the receiver circuitry 105 include conventional circuitry to enable digital or analog transmissions over a wireless communication channel. The transmitter circuitry 103 and the receiver circuitry 105 are designed to operate over both a cellular air interface (e.g., Global System for Mobile communication (GSM), Code Division Multiple Access (CDMA), Wide-band CDMA (WCDMA), Universal Mobile Telecommunications System (UMTS), and the like) and an ad hoc networking air interface (e.g., BLUETOOTH, 802.11 WLAN, 802.16 WiMax, and the like)

The implementations of the transmitter circuitry 103 and the receiver circuitry 105 depend on the implementation of the node 100. For example, the transmitter circuitry 103 and the receiver circuitry 105 can be implemented as an appropriate wireless modem, or as conventional transmitting and receiving components of two-way wireless communication devices. In the event that the transmitter circuitry 103 and the receiver circuitry 105 are implemented as a wireless modem, the modem can be internal to the node 100 or insertable into the node 100 (e.g., embodied in a wireless radio frequency (RF) modem implemented on a Personal Computer Memory Card International Association (PCMCIA) card). For a wireless communication device, the transmitter circuitry 103 and the receiver circuitry 105 are preferably implemented as part of the wireless device hardware and software architecture in accordance with known techniques. Most, if not all, of the functions of the transmitter circuitry 103 and/or the receiver circuitry 105 may be implemented in a processor, such as the processor 101. However, the processor 101, the transmitter circuitry 103, and the receiver circuitry 105 have been artificially partitioned herein to facilitate a better understanding.

The receiver circuitry 105 is capable of receiving RF signals from at least one bandwidth and optionally more bandwidths, if the communications with the proximate device are in a frequency band other than that of the network communications. The receiver circuitry 105 may optionally comprise a first receiver and a second receiver, or one receiver capable of receiving in two or more bandwidths. The receiver 105, depending on the mode of operation, may be tuned to receive, for example, Public Land Mobile Radio System (PLMRS), Advanced Mobile Phone Service (AMPS), GSM, CDMA, UMTS, WCDMA, Bluetooth, or WLAN (e.g., IEEE 802.11) communication signals. The transceiver 102 includes at least one set of transmitter circuitry 103. The at least one transmitter 103 may be capable of transmitting to multiple devices on multiple frequency bands. As with the receiver 105, dual transmitters 103 may optionally be employed where one transmitter is for the transmission to a proximate node or direct link establishment to WLAN's and the other transmitter is for transmission to a cellular base station.

The antenna 106 comprises any known or developed structure for radiating and receiving electromagnetic energy in the frequency range containing the wireless carrier frequencies.

The buffer memory 111 may be any form of volatile memory, such as RAM, and is used for temporarily storing received information packets in accordance with the present invention.

When the node 100 is constructed to receive video information from a video source, the node 100 preferably further includes a video decoder capable of decoding the current Moving Picture Experts Group (MPEG) standard or some other video decoding standard. When the node 100 is further capable of transmitting video information, the node 100 preferably further includes a video encoder capable of encoding the video data into at least one of the foregoing video standards. Such video encoder and decoder is preferably implemented as part of the processor 101.

It is desirable to provide improved authentication techniques for use in ad hoc networks which can simplify authentication of nodes in an ad hoc network. For example, it is desirable to provide improved security techniques in the context of peer-to-peer ad hoc networks which provide simplified association and authentication procedures. In this context, it is also desirable to provide identification and personal verification techniques that are highly secure. To help implement such improved authentication techniques in ad hoc networks, each node can be provided with a secure biometric database (SBD) 117, a biometric input device (BID) 118, and a biometric authentication module 119.

The biometric input device (BID) 118 can be, for example, a fingerprint scanner, a high sensitivity microphone, a camera, a sensor, a handwriting tablet, or other biometric capture device. The biometric input device 118 can be used to input biometric information associated with a given user. The biometric input device 118 allows user(s) to input biometric information that is converted to a biometric code or key for that user and/or node. A biometric key (BK) is a code that can be generated based on or derived from the biometric information, such as a finger print or geometry, a voice sample or pattern, face print or geometry, hand print or geometry, handwriting sample, iris print or pattern, retinal print or other physical characteristic (e.g., scent, thermal image) and/or behavior pattern (e.g., handwriting signature) which can be used to determine a person's identity. For example, in one embodiment, the biometric input device 118 can comprise a fingerprint scanner on each ad hoc node. The scanner can convert the fingerprint into a code. The node(s) can accept one or more finger print codes.

The secure biometric database (SBD) 117 stores a list of codes or keys associated with other nodes in the ad hoc network. These codes or keys are derived from biometric information from the users of the particular nodes. The SBD 117 can store a plurality of first biometric codes associated with users authorized to join the existing ad hoc network. The first biometric codes can be a list of first biometric codes associated with authorized users. Each of the first biometric codes comprises a first biometric input which verifies that a particular authorized user is permitted to be part of and communicate with other nodes in the existing ad hoc network. Each of the first biometric codes can be based on an enrolled biometric sample taken from the authorized users permitted to communicate in the existing ad hoc network, and uniquely identifies a particular authorized user. At deployment of the ad hoc network, during an initial configuration phase, each authorized user can be “enrolled” by submitting a sample of biometric enrollment data (BED) or biometric input from that user. The BED for each user can distributed to each of the nodes and stored in a secure biometric database 117 in each of the nodes that are part of the initial ad hoc network. The first biometric codes can be provided to node 100 by each user, or from a centralized database maintained at a “master” node. Only the nodes which can provide at least one of the codes from the code list is allowed to be part of the existing ad hoc network and communicate with or have access to at least some of the other nodes which are part of the existing ad hoc network. Authorized users can later be added to the secure biometric database 117.

The receiver 105 can receive an authentication request from a node to join the existing ad hoc network. The request comprises a biometric input associated with a first user of the node. The biometric input comprises a second biometric code based on a biometric parameter associated with the first user.

The processor unit 101 includes a biometric authentication module 119 which can authenticate the first user based on the biometric input from the first user and the first biometric codes. The biometric input comprises another biometric code. The biometric authentication module 119 of the processor unit 101 can determine whether the biometric input matches one of the biometric codes to authenticate the first user before the node is permitted to join the ad-hoc network. For example, to authenticate the first user, the processor unit 101 is configured to determine whether the biometric code from the first user matches one of the first biometric codes. The node seeking to join the ad hoc network is prevented from joining the ad hoc network if the biometric code from the first user does not match one of the first biometric codes.

Exemplary Ad Hoc Network

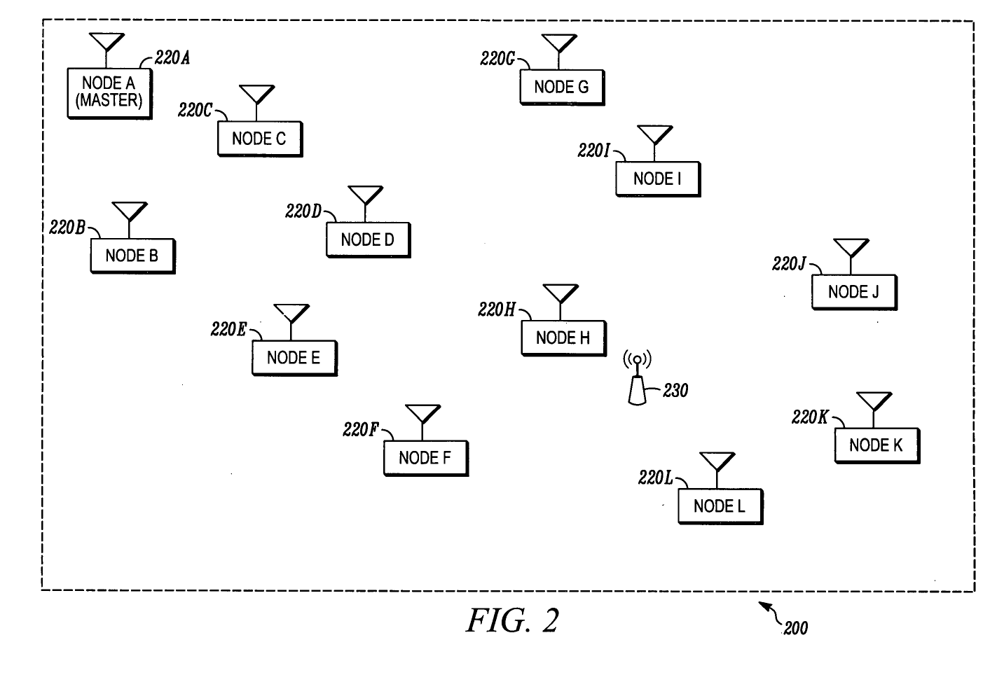

FIG. 2 is a block diagram of an exemplary ad hoc communication network 200.

The ad hoc communication network 200 can be created between a plurality of nodes 220A-220L each having wireless repeater and routing capability, and optionally a wired Access Point (AP) 230. Clients can move seamlessly between infrastructure-based networks and client-based peer-to-peer networks. It will be appreciated by those of ordinary skill in the art that while the ad hoc network 200 in FIG. 2 is shown as operating in an infrastructured mode (e.g., including APs), the ad hoc network 200 of FIG. 2 does not require any network infrastructure to be present. Rather, the nodes 220A-220L typically support simultaneous operation in both infrastructureless mode and infrastructured mode.

In the ad hoc network 200, communications to or from nodes 220A-220L can “hop” through each other to reach other nodes 220A-220L in the network.3 The nodes 220A-220L can generally be wireless devices capable of receiving packetized audio, video and/or data information. Some of the components in an exemplary node, such as an appropriate processor, transmitter, receiver and antenna, are described above in FIG. 1. The nodes 220A-220L can communicate information packets over wireless carrier frequencies, each of which includes one or more wireless communication channels.

In infrastructured mode, the access point 230 is typically coupled to a wired network (not shown) and can provide one or more sources of audio, video and/or data information. The access point 230 may be a cellular base station, a wireless access point that complies with the IEEE 802.11 Standard or other wireless local area network (WLAN) Standards, a Bluetooth access point, or the like. The nodes (e.g., Node H 220H) in close proximity to the AP 230 can receive transmissions from other nodes utilizing the ad hoc air interface and relay these transmissions to infrastructure equipment via an uplink communication signal utilizing, for example, a cellular, Bluetooth or WLAN air interface. Similarly, nodes (e.g., Node H 220H) in close proximity to the AP 230 can receive downlink communications over the cellular, Bluetooth or WLAN air interface and transmit uplink communications to another node via the ad hoc air interface.

Although not shown in FIG. 2, it will be appreciated by those of ordinary skill in the art that the nodes 220A-220L, can also communicate information packets with a cellular-based network (not shown) over wireless carrier frequencies, each of which includes one or more wireless communication channels depending on the multiple access scheme utilized in the cellular-based network. Examples of multiple access schemes which when used in the network can include any one or more of time division multiple access (TDMA), direct sequence or frequency hopping code division multiple access (CDMA), frequency division multiple access (FDMA), orthogonal frequency division multiplexing (OFDM), opportunity division multiple access (ODMA), a combination of any of the foregoing multiple access technologies, a multiple access technology in which portions of the frequency spectrum to be used are determined by local signal quality measurements and in which multiple portions of the frequency spectrum may be used simultaneously, or any other multiple access or multiplexing methodology or combination thereof.

Each node 220A-220L can advertise its presence by periodically broadcasting an advertisement message. In response to the advertisement message, other nodes within range can acknowledge their presence by identifying themselves. In turn, each node can identify its neighbor nodes, and maintain a neighbor list of nodes in proximity to that node. As used herein, a “neighbor node” is a node which is one hop away from the node such that the nodes may communicate with each other. A particular node's neighbor list changes dynamically as the topology of the network changes. At the particular instant in time shown in FIG. 2, node D 220D has five neighbor nodes—node B 220B, node C 220C, node E 220E, node G 220G, and node H 220H.

In the network of FIG. 2, each of the nodes 220A-220L can store first biometric codes associated with users authorized to join the ad hoc network 200. The list of first biometric codes associated with authorized users can be established by receiving first biometric inputs from each of the authorized users (not shown) permitted to be part of and communicate in the ad hoc network 200, and storing the first biometric inputs as a list of codes. Each node can obtain this list, for example, from a master node (e.g., Node A 220A) or from other nodes 220B-220L in the ad hoc network. The biometric inputs from different users can be input into each of the nodes and stored to allow the different users to have access to a particular node or at least some of the nodes which are part of the ad hoc network. Each of the first biometric codes can be based on one or more enrolled biometric samples obtained from each of the users permitted to communicate in the ad hoc network 200. Each biometric code uniquely identifies a particular authorized user who is permitted to communicate in the ad hoc network 200, and can be used to verify that a given node is permitted to communicate with other nodes in the ad hoc network 200. The node can store different biometric identifiers corresponding to different users and then use those different biometric identifiers or keys to control access to different nodes in an ad hoc network and/or to permit a particular user of a node having one of the biometric keys to join or communicate within the ad hoc network.

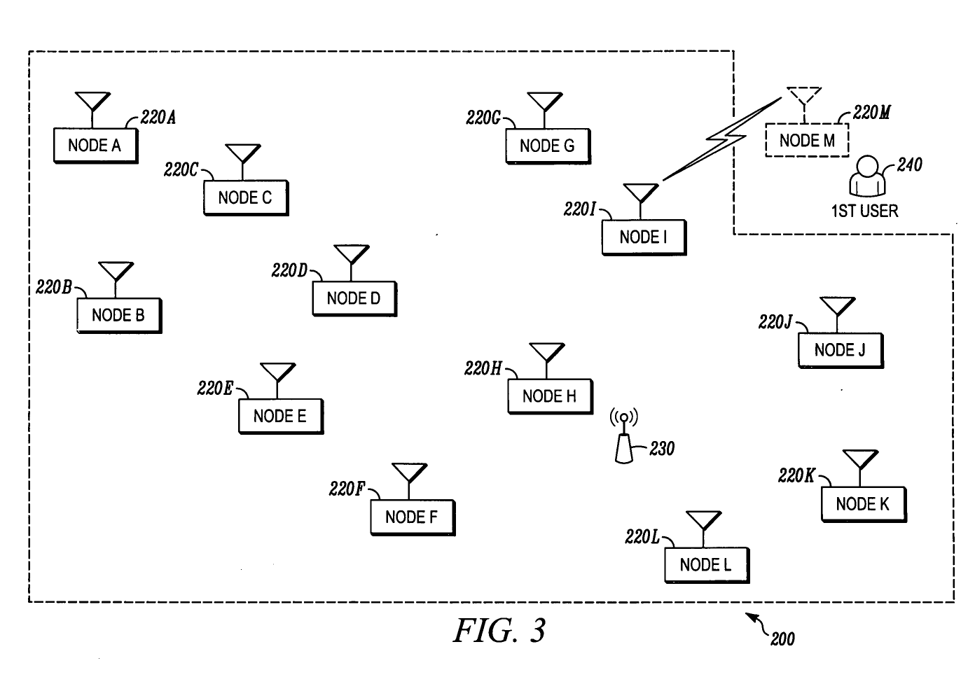

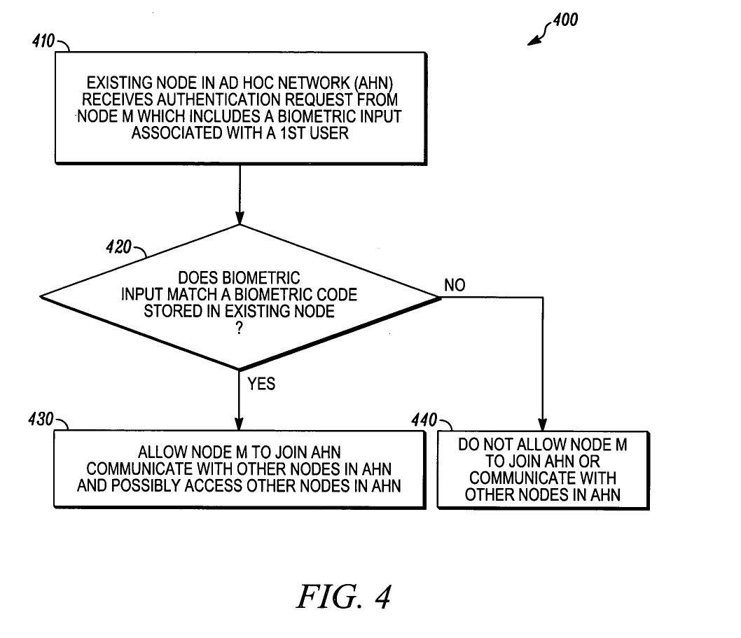

FIG. 3 is a block diagram of the exemplary ad-hoc communication network 200 of FIG. 2 as a new node M 220M enters and attempts to join the ad-hoc communication network 200. FIG. 3 will be described in conjunction with a method 400 of FIG. 4 to describe a technique for authenticating a first node in an ad hoc network 200 in accordance with the present invention.

Exemplary Node Authentication Technique in Secure Ad Hoc Network

When node M 220M enters the ad hoc network 200 and attempts to communicate with another node (e.g., node I 220I) that is part of the ad hoc network 200, node M 220M is prompted to authenticate with the ad hoc network 200. In response, the first user 240 can input a biometric input associated with the first user 240. Alternatively, the if the first user 240 of node M 220M realizes that she does not have a valid biometric code, then the first user 240 can submit a request to one of the nodes (e.g., node I 220I) to join the ad hoc network 200.

At step 410 of FIG. 4, node I 220I can receive an authentication request from node M 220M to join the ad hoc network 200 when node M 220M attempts to connect to one of the nodes that is part of the ad hoc network 200 (shown here as node I 220I). This request includes, among other things, a biometric input associated with a first user 240 of the node M 220M. The biometric input may comprise another biometric code based on a biometric parameter. The biometric input can be generated based on or derived from biometric parameters, such as, a finger print or geometry, a voice sample or pattern, face print or geometry, hand print or geometry, handwriting sample, iris print or pattern, retinal print or other physical characteristic (e.g., scent, thermal image) and/or behavior pattern (e.g., handwriting signature) which can be used to determine a person's identity. The first user 240 of node M 220M can input the biometric information, for example, via a fingerprint scanner, a high sensitivity microphone, a camera, a sensor, or a handwriting tablet. In one implementation, a fingerprint scanner can be provided on node M 220M which converts the fingerprint into a code.

At step 420, node I 220I can authenticate the first user 240 based on the biometric input and the first biometric codes. For instance, before node M 220M is permitted to join the ad hoc network, Node I 220I can determine whether the biometric input (or the second biometric code) matches one of the first biometric codes associated with a list of allowed users by comparing them to the biometric input.

If the biometric input matches one of the biometric codes on the list of biometric codes (e.g., when the second biometric code matches one of the first biometric codes), then at step 430, node M 220M is allowed or permitted to communicate with other nodes in the ad hoc network 200. Only the nodes having at least one of the codes from the code list is allowed to connect to, join and be part of the ad hoc network 200. Those nodes can communicate with and/or possibly have access to at least some of the other nodes 220A-220L which are part of the ad hoc network 200.

If the biometric input does not match one of the biometric codes on the list of biometric codes, then at step 440, node M 220M is prevented from joining the ad hoc network 200. In one implementation, the node I 220I can be presented with a prompt which allows node I 220I to override the need for authentication. In this situation, the user of node I 220I can be presented with a prompt which allows the user to authorize node M 220M to join the ad hoc network 200 despite the fact that the biometric input submitted by node M 220M does not match one of the biometric codes on the list of biometric codes stored in node I 220I. For instance, if the user of node I 220I responds “Yes” to this prompt, then node M 220M will be allowed to join the ad hoc network 200 and communicate with other nodes which are part of the ad hoc network 200.

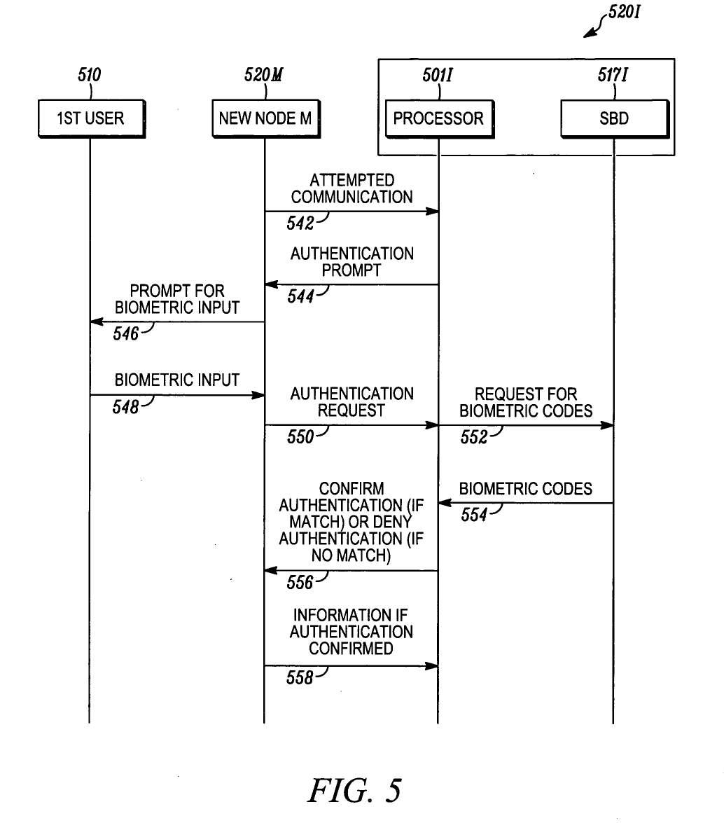

FIG. 5 is a call flow diagram showing message exchanges between two nodes 520M, 520I in an exemplary method for authenticating node 520M in an ad-hoc network in accordance with some embodiments of the invention. FIG. 5 shows a first user 510 of a new node M 520M entering an existing ad hoc network, and an existing node 520I that is part of the existing ad hoc network. Before being permitted to join the ad hoc network and communicate with other nodes in the ad hoc network, the first user 510 of the new node M 520M must first be authenticated as being an authorized user who is permitted to join the ad hoc network and communicate with other nodes in the ad hoc network.

At step 542, new node M 520M attempts to communicate with existing node I 520I. The existing node I 520I includes a processor 501I which can eventually receive the attempted communication from the new node M 520M and determine whether the new node M 520M has been authenticated yet either by the existing node I 520I or another node in the ad hoc network. In this example, it is assumed that new node M 520M has not yet been authenticated.

At step 544, the processor 5011 transmits an authentication prompt to the new node M 520M indicating that the first user 510 and new node M 520M must first be authenticated before being permitted to join the ad hoc network and communicate with other nodes in the ad hoc network. The authentication prompt can also contain a shared public key Kᵢ that the new node M 520M will use to encrypt a portion of its response to the existing node I 520I.

At step 546, the new node M 520M provides a prompt to the first user 510 for the first user 510 to input a biometric input. If the first user 510 for the new node M 520M does not have a valid biometric input for this network, the first user 510 for the new node M 520M can indicate that he is not an authorized user within this ad hoc network, and then submit a request to the existing node I 520I to join the ad hoc network despite this fact. The user of the existing node I 520I can then determine whether or not to allow the first user 510 for the new node M 520M to join. However, to the extent the first user 510 chooses to proceed with the authentication, at step 548, the first user 510 inputs the biometric input to the new node M 520M. At step 550 the new node M 520M converts the biometric input into a biometric code and encrypts the code using the shared public key Kᵢ it received from the existing node I 520I. The new node M 520M then incorporates the encrypted biometric code into an authentication request along with other information such as its own shared public key Kₘ, and transmits that authentication request to the existing node I 520I.

The authentication request is interpreted by the processor 501I and the existing node I 520I decrypts the biometric code using its private key. The existing node I 520I also includes a secure biometric database 517I which stores valid biometric codes associated with authorized users who are permitted to join the ad hoc network and communicate with other nodes in the ad hoc network. At step 552, the processor 501I transmits a request for valid biometric codes to the secure biometric database 517I, and at step 554, the secure biometric database 517I provides the valid biometric codes to the processor 501I. The processor 501I then compares the decrypted biometric code of the first user 510 to the valid biometric codes to determine if there is a match between the biometric code of the first user 510 and any of the valid biometric codes.

If there is not a match between the biometric code of the first user 510 and any of the valid biometric codes, then at step 556, the processor 501I generates an authentication denial message which can then be transmitted to the new node M 520M. By contrast, if there is a match between the biometric code of the first user 510 and any of the valid biometric codes, then at step 556, the processor 501I generates authentication approval message which can then be transmitted to the new node M 520M. The authentication approval message contains additional information such as an ad hoc network public key Kₐₕₙ used to encrypt information exchanged between the new node M 520M and any of the other nodes 220A-220L which are part of the ad hoc network 200. This ad hoc network public key Kₐₕₙ is encrypted with the received public key Kₘ. Once the new node M 520M has been authenticated, at step 558, the new node M 520M is permitted to join the ad hoc network and communicate information to other nodes in the ad hoc network including the existing node I 520I. Each communication thereafter encrypts the information fields with the ad hoc network public key Kₐₕₙ, thus ensuring that nodes that have been denied use of the network are prevented from using the ad hoc network.

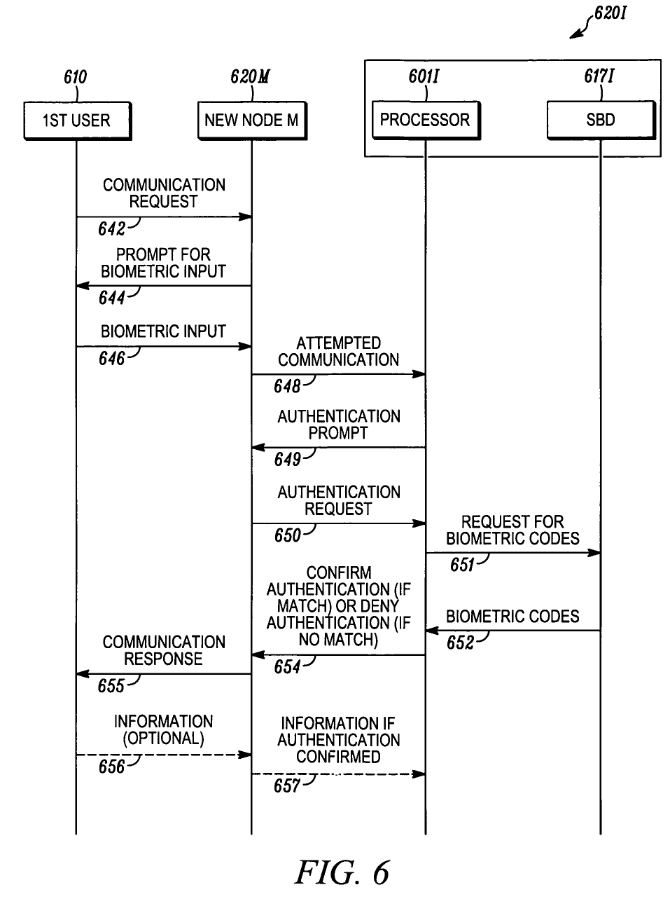

FIG. 6 is a call flow diagram showing message exchanges between two nodes 620M, 620I in another exemplary method for authenticating node 620M in an ad-hoc network in accordance with some embodiments of the invention. FIG. 6 shows a first user 610 of a new node M 620M entering an existing ad hoc network, and an existing node 620I that is part of the existing ad hoc network. Before being permitted to join the ad hoc network and communicate with other nodes in the ad hoc network, the first user 610 of the new node M 620M must first be authenticated as being an authorized user who is permitted to join the ad hoc network and communicate with other nodes in the ad hoc network.

At step 642, first user 610 of the new node M 620M submits a communication request to new node M 620M to communicate with existing node I 620I. The existing node I 620I includes a processor 601I which can eventually receive the attempted communication from the new node M 620M and determine whether the new node M 620M has been authenticated yet either by the existing node I 620I or another node in the ad hoc network. In this example, it is assumed that new node M 620M has not yet been authenticated.

At step 644, new node M 620M generates a prompt to the first user 610 indicating that the first user 610 must first submit a biometric input for authentication before the first user's 610 communication request can be sent to existing node I 620I. The authentication prompt also contains a shared public key Kᵢ that the new node M 620M will use to encrypt a portion of its response to the existing node I 620I.

At step 646, the first user 610 provides a biometric input to the new node M 620M. The new node M 620M converts the biometric input into a biometric code and encrypts the code using the shared public key Kᵢ it received from the existing node I 620I. The new node M 620M then incorporates the encrypted biometric code into an authentication request along with other information such as its own shared public key Kₘ. At step 648, new node M 620M transmits an attempted communication to the existing node I 620I which may include the data the new node M 620M wants to transmit to the existing node I 620I.

At step 649, the existing node I 620I generates an authentication prompt and transmits it to the new node M 620M. The authentication prompt includes a shared public key Kᵢ from the authenticating node I 620I.

At step 650, in response to the authentication prompt, new node M 620M transmits that authentication request to the existing node I 620I. The new node M 520M converts the biometric input into a biometric code and encrypts the code using the shared public key Kᵢ it received from the existing node I 520I. The new node M 520M then incorporates the encrypted biometric code into an authentication request along with other information such as its own shared public key Kₘ, and transmits that authentication request to the existing node I 520I.

The authentication request is interpreted by the processor 601I and the existing node I 620I decrypts the biometric code using its private key. The existing node I 620I also includes a secure biometric database 617I which stores valid biometric codes associated with authorized users who are permitted to join the ad hoc network and communicate with other nodes in the ad hoc network. At step 651, the processor 601I transmits a request for valid biometric codes to the secure biometric database 617I, and at step 652, the secure biometric database 617I provides the valid biometric codes to the processor 601I. The processor 601I then compares the decrypted biometric code of the first user 610 to the valid biometric codes to determine if there is a match between the biometric code of the first user 610 and any of the valid biometric codes.

If there is not a match between the biometric code of the first user 610 and any of the valid biometric codes, then at step 654, the processor 601I generates an authentication denial message which can then be transmitted to the new node M 620M. By contrast, if there is a match between the biometric code of the first user 610 and any of the valid biometric codes, then at step 654, the processor 601I generates authentication approval message which can then be transmitted to the new node M 620M. The authentication approval message contains additional information such as an ad hoc network public key Kₐₕₙ used to encrypt information exchanged between the new node M 620M and any of the other nodes which are part of the ad hoc network. This ad hoc network public key Kₐₕₙ is encrypted with the received public key Kₘ. At step 655 a communication response message is provided to the first user 610 by the new node M 620M. The communication response message notified the first user 610 that her communication request at step 642 was either confirmed or denied by node 620I, and hence whether authentication was successful.

Once the new node M 620M has been authenticated the new node M 620M is permitted to join the ad hoc network and communicate information to other nodes in the ad hoc network including the existing node I 620I. Each communication thereafter encrypts the information fields with the ad hoc network public key Kₐₕₙ, thus ensuring that nodes that have been denied use of the network are prevented from using the ad hoc network. If authentication was successful, then at step 656, the first user 610 may optionally submit information to the new node M 620M, and at step 657 information can be transmitted from new node M 620M to the existing node 620I.

Thus, security techniques are provided for use in peer-to-peer ad hoc networks which can allow for improved authentication procedures. Each authentication attempt by a particular node to bond to or associate with other nodes will succeed only if the particular node has a particular biometric code. Authentication is greatly simplified via the use of biometric information and the keys or codes provided from that biometric information. Each node or device in the ad hoc network can have a secure database which stores a list of codes or keys associated with other nodes in the ad hoc network. These codes or keys can be derived from biometric information from the users of the particular devices. Each node that has a biometric input device which allows a user to input biometric information that is converted to a key or code for that device. Any device in the ad hoc network can decide whether or not it wants to permit communication with another device by determining whether that device has a biometric key or code that matches one that is stored in the device. If the biometric key or code matches then communication can be permitted. By contrast if the key does not match then communication may not be permitted. The codes can be obtained in a number of different ways. According to one technique, a central controller or central database or authority manages biometric keys for all devices in the ad hoc network. Thus, a given node in an ad hoc network can store different biometric identifiers corresponding to different users and then use those different biometric identifiers or keys to control access to different devices in an ad hoc network and/or to permit a particular user of a device having one of the biometric keys to join or communicate within an ad hoc network.

In the foregoing specification, specific embodiments of the present invention have been described. However, one of ordinary skill in the art appreciates that various modifications and changes can be made without departing from the scope of the present invention as set forth in the claims below. For example, while the description above describes authentication of nodes in an ad hoc network, it should be appreciated that these concepts can also be applied, for example, to multicast groups as well, where a subset of nodes in the ad-hoc network belongs to a multicast group.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of authenticating a first node in an ad hoc network comprising at least one existing node configured to store biometric codes associated with users authorized to join the ad hoc network, comprising:
receiving a request from a first node to join the ad hoc network, wherein the request comprises a biometric input associated with a first user of the first node; and
authenticating the first user based on the biometric input and the stored biometric codes.

2. A method according to claim 1, further comprising:
establishing a list of stored biometric codes associated with authorized users permitted to be part of and communicate in the ad hoc network.

3. A method according to claim 1, wherein receiving a request from a first node to join the ad hoc network, wherein the request comprises a biometric input associated with a first user of the first node, comprises:
receiving an authentication request from the first node at the existing node when the first node attempts to connect to the ad hoc network, wherein the authentication request comprises biometric input associated with a first user of the first node, wherein the biometric input comprises a first biometric code based on a biometric parameter.

4. A method according to claim 1, wherein authenticating the first user based on the biometric input, comprises:
determining whether the biometric input matches one of the stored biometric codes before the first node is permitted to join the ad-hoc network.

5. A method according to claim 1, further comprising:
allowing the first node to communicate with other nodes in the ad hoc network if the biometric input matches one of the biometric codes on the list of biometric codes.

6. A method according to claim 3, wherein authenticating the first user based on the biometric input and the stored biometric codes, comprises:
determining whether the first biometric code matches one of the stored biometric codes.

7. A method according to claim 6, further comprising:
allowing the first node to communicate with other nodes in the ad hoc network when the first biometric code matches one of the stored biometric codes; and
preventing the first node from joining the ad hoc network if it is determined that the first biometric code does not match one of the stored biometric codes.

8. A method according to claim 1, wherein each of the stored biometric codes is based on an enrolled biometric sample obtained from the users permitted to communicate in the ad hoc network.

9. A method according to claim 2, wherein establishing a list of stored biometric codes associated with authorized users permitted to communicate in the ad hoc network, comprises:
receiving a first biometric input from each of the authorized users permitted to communicate in the ad hoc network, and
storing the first biometric inputs as a list of codes, wherein each code uniquely identifies a particular authorized user permitted to communicate in the ad hoc network.

10. A method according to claim 9, wherein only the nodes having at least one of the codes from the code list is allowed to be part of the ad hoc network and communicate with or have access to at least some of the other nodes which are part of the ad hoc network.

11. A first node configured to authenticate other nodes in an existing ad hoc network, comprising:
a memory configured to store a plurality of valid biometric codes associated with each user authorized to join the existing ad hoc network;
a receiver configured to receive a request from a second node to join the existing ad hoc network, wherein the request comprises a biometric input associated with a first user of the second node; and
a processor configured to authenticate the first user based on the biometric input and the valid biometric codes.

12. A first node according to claim 11, wherein the valid biometric codes associated comprises a list of valid biometric codes associated with authorized users, wherein each of the valid biometric codes comprises a first biometric input which verifies that the authorized user is permitted to be part of and communicate with other nodes in the existing ad hoc network.

13. A first node according to claim 11, wherein the request comprises:
an authentication request from the second node comprising a biometric input associated with a first user of the second node,
wherein the biometric input comprises a first biometric code based on a biometric parameter associated with the first user.

14. A first node according to claim 13, wherein the processor is configured to determine whether the first biometric code matches one of the valid biometric codes to authenticate the first user before the second node is permitted to join the ad-hoc network.

15. A first node according to claim 14, wherein the second node is prevented from joining the ad hoc network if the first biometric code does not match one of the valid biometric codes.

16. A first node according to claim 11, wherein each of the valid biometric codes is based on an enrolled biometric sample taken from the authorized users permitted to communicate in the existing ad hoc network, wherein each biometric code uniquely identifies a particular authorized user.

17. A first node according to claim 12, wherein only the nodes having at least one of the codes from the code list is allowed to be part of the existing ad hoc network and communicate with or have access to at least some of the other nodes which are part of the existing ad hoc network.

18. An ad hoc network, comprising:
a first node configured to transmit a request to join the ad hoc network, wherein the request comprises a biometric input associated with a first user of the first node; and
at least one existing node configured to store biometric codes associated with users authorized to join the ad hoc network, wherein the existing node is configured to receive the request and authenticate the first user based on the biometric input and the stored biometric codes.

19. An ad hoc network according to claim 18, wherein the stored biometric codes are associated with authorized users permitted to be part of and communicate in the ad hoc network, and wherein the request comprises an authentication request from the first node to connect to the ad hoc network, wherein the authentication request comprises a biometric input associated with the first user.

20. An ad hoc network according to claim 19, wherein the existing node is configured to determine whether the biometric input matches one of the stored biometric codes before the first node is permitted to join the ad-hoc network by determining whether the first biometric code matches one of the stored biometric codes, and wherein the first node is allowed to communicate with other nodes in the ad hoc network if the first biometric code matches one of the stored biometric codes, and wherein the first node is prevented from joining the ad hoc network if it is determined that the first biometric code does not match one of the stored biometric codes.
